(19) United States
(12) Patent Application Publication
(10) Pub. No.: US 2026/0214324 A1
(43) Pub. Date: Jul. 23, 2026

(54) IMAGE CAPTURE APPARATUS AND INFORMATION PROCESSING APPARATUS

(71) Applicant: CANON KABUSHIKI KAISHA, Tokyo (JP)

(72) Inventor: Takashi ASAKA, Tokyo (JP)

(21) Appl. No.: 19/443,208

(22) Filed: Jan. 8, 2026

(30) Foreign Application Priority Data
Jan. 20, 2025 (JP) 2025-007978

(51) Int. Cl. H04N 23/661; H04N 7/18

(52) U.S. Cl. CPC H04N 23/661; H04N 7/181

(57) ABSTRACT

An image capture apparatus includes a first communication unit that communicates with a first apparatus using a first communication method, a second communication unit that is capable of communicating with a second apparatus using a second communication method in which a communicable distance is shorter than that of the first communication method, and performs first control for causing the first communication unit to transmit, at a first data size, the captured image to the first apparatus, and second control for causing the first communication unit to transmit, to the first apparatus, a portion of the captured image having a second data size larger than the first data size, and for causing the second communication unit to transmit at least another portion of the image to the second apparatus.

### BACKGROUND

### Field of the Technology

The present disclosure relates to a remote monitoring system using a plurality of image capture apparatuses.

### Description of the Related Art

As a long-distance wireless communication method utilized in a system for remotely monitoring wide areas such as maritime areas and the like by remotely controlling a plurality of image capture apparatuses, wireless communication standards such as IEEE 802.11ah have been known.

However, in conventional wireless communication methods, an effective data rate is about several Mbps and some communication standards have restriction on the transmission duty cycle. For example, in a case where the IEEE 802.11ah is utilized in Japan, the transmission duty cycle may be limited to 10%, and when continuous communication is performed, transmission pause periods are required intermittently. For example, in a case where videos are continuously transmitted, a transmission pause period nine times the transmission time necessary for transmitting one frame is required.

In Japanese Patent Laid-Open No. 2019-195178, there has been described a method of using a high-speed communication method from among a plurality of communication methods. However, in a case where long-distance wireless communication is performed with a plurality of image capture apparatuses, even if a high-speed communication method can be used, communication cannot be performed if the communicable distance is not sufficient.

In a remote monitoring system, in a case where a suspicious object is captured in a monitored area, it is desirable to be able to improve the image quality and frame rate of the video in order to confirm details of the suspicious object. However, in a case where the effective data rate of the wireless communication method is low or in a case where there is a restriction on the transmission duty cycle, it is difficult to transmit a high-quality video and a high-frame-rate video compared to the normal condition.

### SUMMARY

The present disclosure has been made in consideration of the aforementioned problems, and provides technical advantages that, in a remote monitoring system using a plurality of image capture apparatuses, a high-quality video and a high-frame-rate video can be transmitted as needed.

In order to solve the aforementioned problems, the present disclosure is directed to an image capture apparatus comprising: an image capture unit; an image processing unit that performs image processing on an image captured by the image capture unit; a first communication unit that communicates with a first apparatus using a first communication method; a second communication unit that is capable of communicating with a second apparatus using a second communication method in which a communicable distance is shorter than that of the first communication method; and a control unit that performs: first control for causing the first communication unit to transmit, at a first data size, the image captured by the image capture unit to the first apparatus; and second control for causing the first communication unit to transmit, to the first apparatus, a portion of the image captured by the image capture unit and having a second data size larger than the first data size, and for causing the second communication unit to transmit at least another portion of the image to the second apparatus.

According to the present disclosure, in a remote monitoring system using a plurality of image capture apparatuses, a high-quality video and a high-frame-rate video can be transmitted as needed.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying the configuration of an image capture apparatus according to a first embodiment;

FIG. 2 is a block diagram exemplifying the configuration of a monitoring apparatus according to the first embodiment;

FIG. 3 is a diagram illustrating a method of communication between the image capture apparatuses and the monitoring apparatus according to the first embodiment;

FIGS. 4A to 4D are diagrams illustrating an image division method according to the first embodiment;

FIG. 5 is a block diagram exemplifying the configuration of a monitoring apparatus according to a second embodiment;

FIG. 6 is a diagram illustrating a communication method between the image capture apparatuses and the monitoring apparatus according to the second embodiment;

FIG. 7 is a diagram illustrating a communication method based on image division according to the second embodiment;

FIG. 8 is a diagram illustrating a communication method based on frame division according to the second embodiment; and

FIG. 9 is a diagram illustrating the conventional background.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the embodiments, explanations will be given as to a configuration that enables transmission of a high-quality video and a high-frame-rate video as needed in a system for remotely monitoring wide areas such as maritime areas and the like, in which a plurality of image capture apparatuses and a monitoring apparatus are connected to be able to perform long-distance wireless communication.

### First Embodiment

First, an explanation will be given as to a first embodiment.

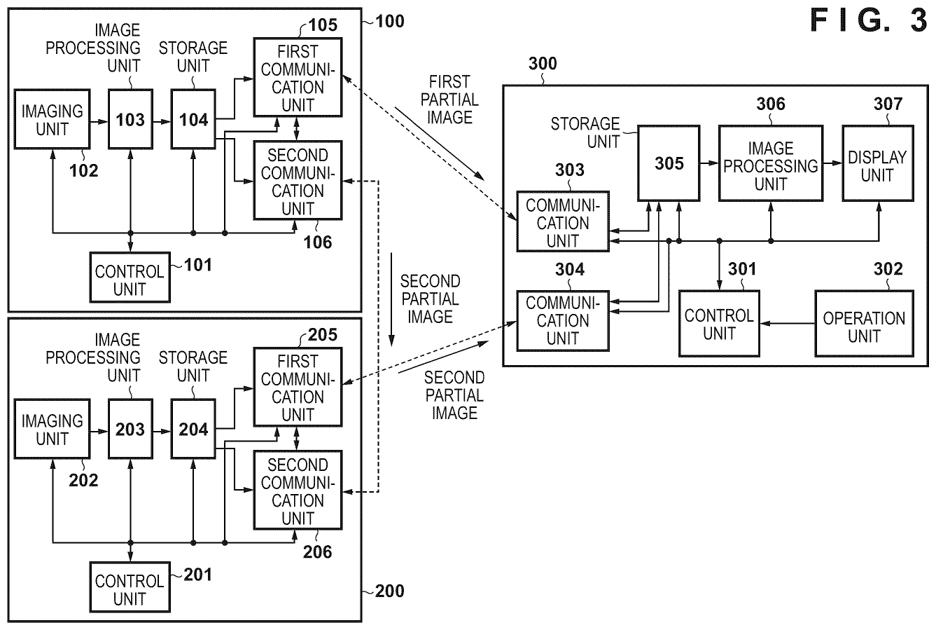

In the first embodiment, an explanation will be given as to a system in which as illustrated in FIG. 3, a plurality of image capture apparatuses 100 and 200 are communicably connected to a monitoring apparatus 300, and the plurality of image capture apparatuses 100 and 200 are also communicably connected to each other.

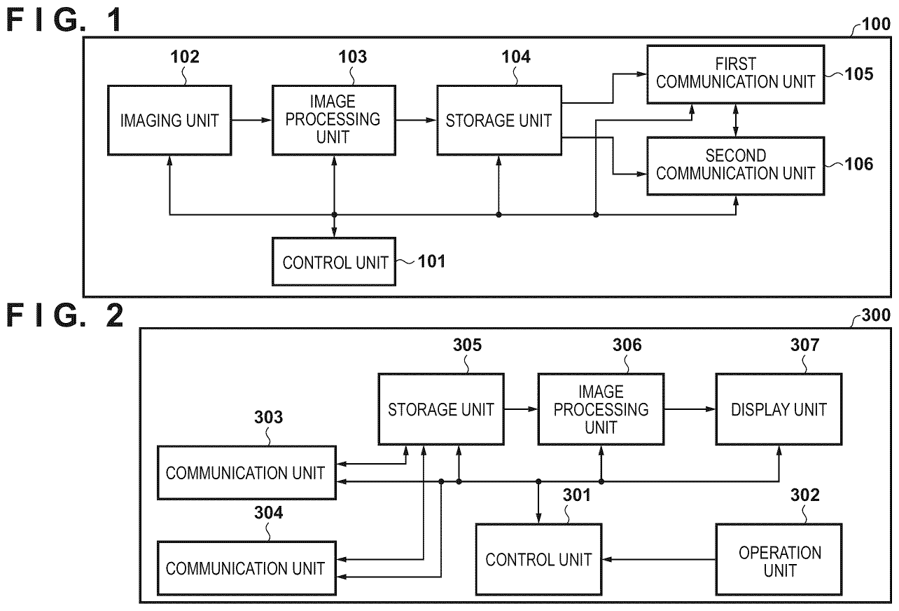

FIG. 1 is a block diagram exemplifying the configuration of the image capture apparatus 100 according to the present embodiment.

The image capture apparatus 100 of the present embodiment is a digital camera capable of wireless communication with external apparatuses such the other image capture apparatus 200 and the monitoring apparatus 300, which are described later and are included in the system of the present embodiment. The image capture apparatus 100 can transmit and receive image data and other data to and from the image capture apparatus 200 and the monitoring apparatus 300 by a wireless communication method. The monitoring apparatus 300 can remotely control the operating states of the image capture apparatuses 100 and 200 by the wireless communication method. In the present embodiment, an explanation will be given as to a case in which the plurality of image capture apparatuses 100 and 200 transmit and receive moving image data to and from the monitoring apparatus 300, and the image capture apparatuses 100 and 200 transmit and receive the moving image data to and from each other.

A control unit 101 includes arithmetic processing processors such as a CPU and an MPU that control the overall operation of the image capture apparatus 100 as well as memories such as a ROM and a RAM. By executing programs stored in the ROM or in a storage unit 104 described later, the control unit 101 implements the control processing in the present embodiment.

An imaging unit 102 includes an optical system having a lens, an aperture, and the like, and an image sensor that converts object image light formed by the optical system into an electrical signal, and generates still image data and moving image data composed of analog signals.

An image processing unit 103 performs image processing on the image data generated by the imaging unit 102 and stores the processed image data in a storage unit 104. The image processing includes resizing processing and color conversion processing, processing for dividing the image data into multiple regions, processing for dividing the image data on a per-pixel basis, processing for dividing the image data on a per-interlaced-scan basis, and compression processing for reducing the amount of data.

The control unit 101 performs auto focus (AF) processing and auto exposure (AE) processing by controlling the optical system based on results of the image processing by the image processing unit 103.

The storage unit 104 is a memory that temporarily stores the image data processed by the image processing unit 103.

A first communication unit 105 and a second communication unit 106 are interfaces for connecting to an external apparatus by the wireless communication method. The image capture apparatus 100 of the present embodiment can transmit and receive data to and from the external apparatus via the first communication unit 105 or the second communication unit 106. The external apparatus is the other image capture apparatus 200 or the monitoring apparatus 300.

The first communication unit 105 is capable of communicating by a first communication method compliant with a wireless communication standard such as the IEEE 802.11ah.

The second communication unit 106 is capable of communicating by a second communication method compliant with the wireless communication standard such as IEEE 802.11n. The second communication method has a shorter communicable range but a higher communication speed compared to the first communication method. In other words, the first communication method has a longer communicable range but a lower communication speed compared to the second communication method. The second communication method is not limited to the wireless communication such as the IEEE 802.11n and may be a wired communication method, such as Ethernet (registered trademark).

Each of components 201 to 206 of the image capture apparatus 200 is equivalent to each of the components 101 to 106 of the image capture apparatus 100. In addition, because the first communication unit 205 of the image capture apparatus 200 uses a channel (frequency band) different from that used in the first communication unit 105 of the image capture apparatus 100, the image capture apparatuses 100 and 200 can communicate simultaneously.

FIG. 2 is a block diagram exemplifying the configuration of the monitoring apparatus 300 according to the present embodiment.

The monitoring apparatus 300 of the present embodiment is an information processing apparatus capable of wireless communication with the image capture apparatuses 100 and 200. The monitoring apparatus 300 displays the image data captured by the image capture apparatuses 100 and 200 for a user to utilize for monitoring.

A control unit 301 includes arithmetic processing processors such as a CPU and an MPU that control the overall operation of the monitoring apparatus 300, and memories such as a ROM and a RAM. By executing programs stored in the ROM or in a storage unit 305 described later, the control unit 301 implements the control processing of the present embodiment.

An operation unit 302 is an input device that accepts user operations, and is capable of changing the operating state of the monitoring apparatus 300 and, via communication, changing the operating states of the image capture apparatus 100 and the image capture apparatus 200.

A communication unit 303 is a block that includes a network interface and an antenna used for the monitoring apparatus 300 to communicate with the image capture apparatus 100. The communication unit 303 performs communication based on the IEEE 802.11ah standard or the like that assumes long-distance communication.

A communication unit 304 is a block that includes a network interface and an antenna used for the monitoring apparatus 300 to communicate with the image capture apparatus 200, and is equivalent to the communication unit 303.

The storage unit 305 is a memory that stores image data received from the communication unit 303 and the communication unit 304. The storage unit 305 may store the received image data in a non-volatile area.

An image processing unit 306 is a processor that performs processing such as decompression of compressed images received from the image capture apparatuses 100 and 200 and merging of partial images.

A display unit 307 is an LCD panel or the like that displays the images processed by the image processing unit 306 in such a manner as to be viewable by a user of the monitoring apparatus 300. The display unit 307 may not be configured to be a built-in component of the monitoring apparatus 300, but may be configured to be an externally attached component.

Next, with reference to FIG. 3, an explanation will be given as to a mode in which the image capture apparatus 100 and the image capture apparatus 200 communicate with the monitoring apparatus 300 of the present embodiment.

A first mode is a steady state. In the first mode, the image capture apparatus 100 and the image capture apparatus 200 perform capturing by the imaging unit 102 and an imaging unit 202, respectively. The image capture apparatus 100 and the image capture apparatus 200 perform image processing (compression) of the captured images, which the imaging unit 102 and the imaging unit 202 have captured, by the image processing unit 103 and an image processing unit 203, respectively, to convert the captured images into data sizes suitable for communication. Respective processed images are temporarily stored in the storage unit 104 and a storage unit 204 and are transmitted to the monitoring apparatus 300 by the first communication unit 105 and a first communication unit 205.

The monitoring apparatus 300 receives respective images by the communication unit 303 and the communication unit 304 and stores the received images in the storage unit 305. The image processing unit 306 reads out the respective images from the storage unit 305 and performs image processing (decompression). The image processing unit 306 then arranges the respective images in a predetermined layout and displays the laid-out images on the display unit 307. Here, a user of the monitoring apparatus 300 outputs instructions to the control unit 301 by the operation unit 302, and the control unit 301 controls the image processing unit 306 to change the layout of the images to be displayed on the display unit 307 to a desired setting.

A second mode is a state different from the steady state. The second mode is employed, for example, for a case where a user checks the display unit 307 and wishes to improve the image quality and the frame rate in order to confirm details of a specific image, in this embodiment, the image captured by the image capture apparatus 100. Communication between the image capture apparatuses 100 and 200 and the monitoring apparatus 300 is suitable for long-distance communication between the first communication unit 105 and the communication unit 303; however, there is a restriction that a sufficient communication speed cannot be attained. For example, in a case where the IEEE 802.11ah is utilized in Japan, as shown in FIG. 9, the transmission duty cycle may be limited to 10%, and in a case where continuous communication is performed, intermittent transmission pause periods are required. For example, in a case where video is continuously transmitted, a transmission pause period nine times the transmission time necessary for transmitting one frame is required. Therefore, in the second mode, in the monitoring apparatus 300, when receiving a user instruction via the operation unit 302, the control unit 301 instructs, via the communication unit 303, the image capture apparatus 100 to divide the image into portions and transmit the divided image to the image capture apparatus 200. The control unit 301 instructs the image capture apparatus 100 to transmit to the monitoring apparatus 300 a portion of the image that has not been not transmitted to the image capture apparatus 200. In addition, the control unit 301 instructs, via the communication unit 304, the image capture apparatus 200 to transmit the portion of the image received from the image capture apparatus 100 to the monitoring apparatus 300.

The image capture apparatus 100 that has received the instruction from the control unit 301, divides the image captured by the image processing unit 103 into a first partial image and a second partial image, and temporarily stores the divided first partial image and the second partial image in the storage unit 104. In this case, the image quality or the frame rate is to be improved compared to that in the first mode. The first communication unit 105 reads out the first partial image from the storage unit 104 and transmits the readout image to the communication unit 303 of the monitoring apparatus 300. The second communication unit 106 reads out the second partial image from the storage unit 104 and transmits the readout image to a second communication unit 206 of the image capture apparatus 200.

The second communication unit 206 of the image capture apparatus 200 temporarily stores the received second partial image in the storage unit 204. Next, the first communication unit 205 reads out the second partial image from the storage unit 204 and transmits the readout image to the communication unit 304 of the monitoring apparatus 300.

The communication unit 303 and the communication unit 304 of the monitoring apparatus 300 store the received first partial image and second partial image in the storage unit 305. The image processing unit 306 reads out the first partial image and the second partial image from the storage unit 305, performs image processing (merging), and displays the processed partial images on the display unit 307. Accordingly, the user of the monitoring apparatus 300 can confirm the image captured by the image capture apparatus 100 with an image quality or a frame rate that is improved compared to the steady-state.

In this embodiment, the instruction was issued from the control unit 301 of the monitoring apparatus 300 to both of the image capture apparatus 100 and the image capture apparatus 200. However, it may be sufficient to issue the instruction only to the image capture apparatus 100 that performs the image division. In this case, based on the instruction from the control unit 301, the control unit 101 of the image capture apparatus 100 instructs, via the second communication unit 106, the control unit 201 of the image capture apparatus 200 to transmit the divided images to the monitoring apparatus 300.

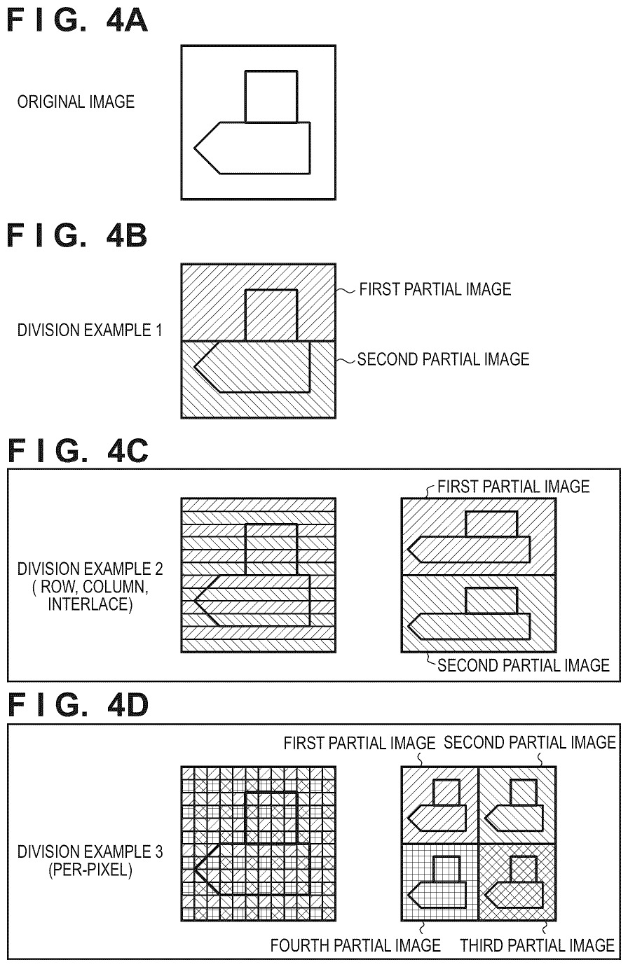

Next, with reference to FIGS. 4A to 4D, an explanation will be given as to an image division method performed by the image capture apparatus 100 of the present embodiment.

The image division method in the image capture apparatus 100 can be set by a user, for example, via the operation unit 302 of the monitoring apparatus 300. The monitoring apparatus 300 can set, by transmitting the user's setting to the image capture apparatus 100, the image division method in the image processing unit 103. In addition, the control unit 301 instructs the image processing unit 306 a method for merging the divided images.

FIG. 4A exemplifies the captured image before division (original image). FIG. 4B exemplifies the image divided using a first division method. In the first division method, the original image is simply divided into multiple regions to generate the first partial image and the second partial image. In this case, if either one of the first partial image and the second partial image is not transmitted to the monitoring apparatus 300 due to a communication failure or the like, the non-transmitted image will be missing.

FIG. 4C exemplifies the image divided using the second division method. In the second division method, the original image is divided row by row or column by column, or the original image is divided into two fields to generate an interlaced image. In this case, even if either one of the first partial image and the second partial image is not transmitted to the monitoring apparatus 300 due to the communication failure or the like, overview of the entire image can be confirmed.

FIG. 4D exemplifies the image divided using a third division method. In the third division method, the original image is divided on a per-pixel basis. In the example of FIG. 4D, the image is divided into four regions. In this embodiment, the image capture apparatus 100 transmits the first partial image and the third partial image to the monitoring apparatus 300, and the image capture apparatus 200 transmits the second partial image and the fourth partial image to the monitoring apparatus 300. In this case also, even if any of the partial images has not been transmitted to the monitoring apparatus 300 due to the communication failure or the like, the overview of the entire image can be confirmed. In addition, even in a case where the number of image capture apparatuses connected to the monitoring apparatus 300 is increased, it becomes easy to be coped with.

Although not illustrated, it is also possible for the image capture apparatus 100 and the image capture apparatus 200 to alternately transmit the image in the order of moving picture frames without dividing the image into regions.

As described above, according to the first embodiment, in the remote monitoring system or the like using multiple image capture apparatuses, as the image capture apparatuses 100 and 200 cooperate to transmit partial images to the monitoring apparatus 300, it is possible to display the images with an image quality and a frame rate that are improved compared to the steady state. Hence more detailed monitoring can be performed.

### Second Embodiment

In the first embodiment, it has been described the processing in which, as the monitoring apparatus 300 performs long-distance communication, using multiple channels, with the image capture apparatus 100 and the image capture apparatus 200, the processing makes it possible to confirm the images with the image quality and the frame rate that are improved compared to the steady state. In contrast, in the second embodiment, an explanation will be given as to processing in which, in a case where the monitoring apparatus 300 performs long-distance communication, using a single channel, with the image capture apparatus 100 and the image capture apparatus 200, the processing makes it possible to confirm the images with the improved image quality and the improved frame rate.

The configurations of the image capture apparatus 100 and the image capture apparatus 200 in the present embodiment are as explained with reference to FIG. 1.

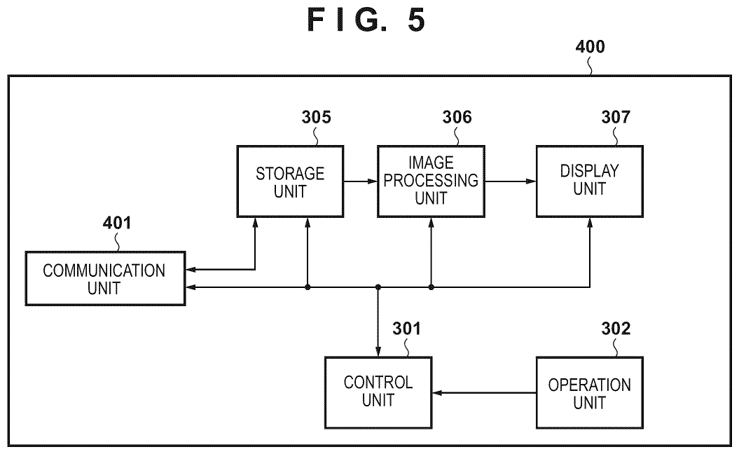

FIG. 5 is a block diagram exemplifying the configuration of a monitoring apparatus 400 according to the second embodiment. Components that are the same as those of the monitoring apparatus 300 in FIG. 2 are denoted by the same reference numerals, and a description thereof is omitted.

A communication unit 401 is a block that includes a network interface and an antenna used by the monitoring apparatus 400 to communicate with the image capture apparatus 100 and the image capture apparatus 200. The communication unit 401 performs communication using the IEEE 802.11ah standard and the like that assumes long-distance communication.

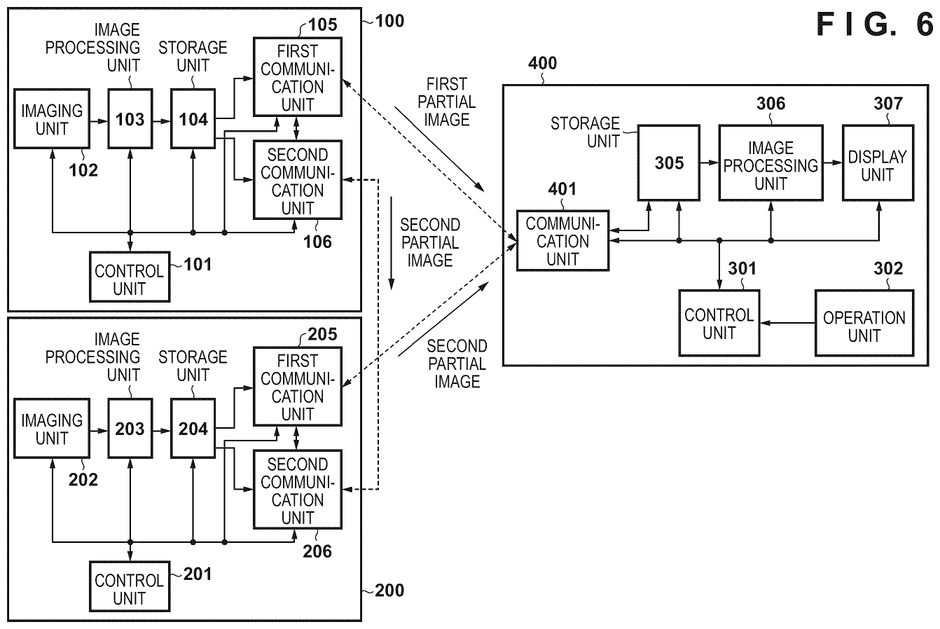

Next, with reference to FIG. 6, an explanation will be given as to a communication mode in which the image capture apparatus 100 and the image capture apparatus 200 communicate with the monitoring apparatus 400 according to the present embodiment.

In the first mode, the image capture apparatus 100 and the image capture apparatus 200 capture images by the imaging unit 102 and the imaging unit 202, respectively. The image processing unit 103 and the image processing unit 203 process (compress) the respective captured images and convert the processed images into data sizes suitable for communication. The respective processed images are temporarily stored in the storage unit 104 and the storage unit 204 and transmitted to the monitoring apparatus 400 by the first communication unit 105 and the first communication unit 205. In this case, since the first communication unit 105 and the first communication unit 205 use the same channel, these units cannot perform communication simultaneously, thus performing communication in a time-division manner.

The monitoring apparatus 400 receives partial images from the image capture apparatuses 100 and 200 via the communication unit 401 and stores the received partial images in the storage unit 305. The image processing unit 306 reads out the partial images from the storage unit 305 and performs image processing (decompression) for the partial images. The image processing unit 306 then arranges respective images in a predetermined layout and displays the laid-out images on the display unit 307. Here, a user of the monitoring apparatus 400 outputs an instruction to the control unit 301 using the operation unit 302, and the control unit 301 can change, by controlling the image processing unit 306, the layout of the images to be displayed on the display unit 307 to a desired setting.

The second mode is employed for a case where the user checks the display unit 307 and wishes to improve the image quality and the frame rate in order to confirm details of a specific image, in this embodiment, details of the image captured by the image capture apparatus 100. However, the communication between the first communication unit 105 and the communication unit 401 in the second mode is suitable for long-distance communication, which has a restriction that sufficient communication speed cannot be attained. In addition, because the image captured by the image capture apparatus 200 is also to be transmitted over the same channel, it becomes a factor that hinders improvement in the communication speed.

Accordingly, in the second mode, the control unit 301 that has received the user instruction from the operation unit 302, instructs via the communication unit 401 the image capture apparatus 100 to divide a portion of the image and transmit the divided image to the image capture apparatus 200. The control unit 301 also instructs the image capture apparatus 100 to transmit a portion of the image, which has not been transmitted to the image capture apparatus 200, to the monitoring apparatus 400. In addition, the control unit 301 instructs, via the communication unit 401, the image capture apparatus 200 to transmit the portion of the image received from the image capture apparatus 100 to the monitoring apparatus 400.

The image capture apparatus 100, which has received the instruction from the control unit 301, divides the captured image into the first partial image and the second partial image by the image processing unit 103, and temporarily stores the first partial image and the second partial image in the storage unit 104. In this case, the image quality or the frame rate is to be improved compared to that in the first mode. The first communication unit 105 reads out the first partial image from the storage unit 104 and transmits the readout first partial image to the communication unit 401 of the monitoring apparatus 400. The second communication unit 106 reads out the second partial image and transmits the readout second partial image to the second communication unit 206 of the image capture apparatus 200.

The second communication unit 206 of the image capture apparatus 200 temporarily stores the received second partial image in the storage unit 204. Next, the first communication unit 205 reads out the second partial image from the storage unit 204 and transmits the readout second partial image to the communication unit 401 of the monitoring apparatus 400.

The communication unit 401 of the monitoring apparatus 400 stores, in the storage unit 305, the first partial image and the second partial image received from the image capture apparatuses 100 and 200 in the time-division manner. The image processing unit 306 reads out the first partial image and the second partial image stored in the storage unit 305, performs image processing (merging), and displays the processed image on the display unit 307. Accordingly, the user of the monitoring apparatus 400 can confirm the image captured by the image capture apparatus 100 with improved image quality or frame rate compared to that of the first mode.

In this embodiment, although the instruction was issued from the control unit 301 of the monitoring apparatus 400 to both of the image capture apparatus 100 and the image capture apparatus 200, the instruction may be issued only to the image capture apparatus 100 that performs image division. In this case, based on the instruction from the control unit 301 of the monitoring apparatus 400, the control unit 101 of the image capture apparatus 100 issues an instruction to the control unit 201 of the image capture apparatus 200, via the second communication unit 106, to transmit the partial image to the monitoring apparatus 400.

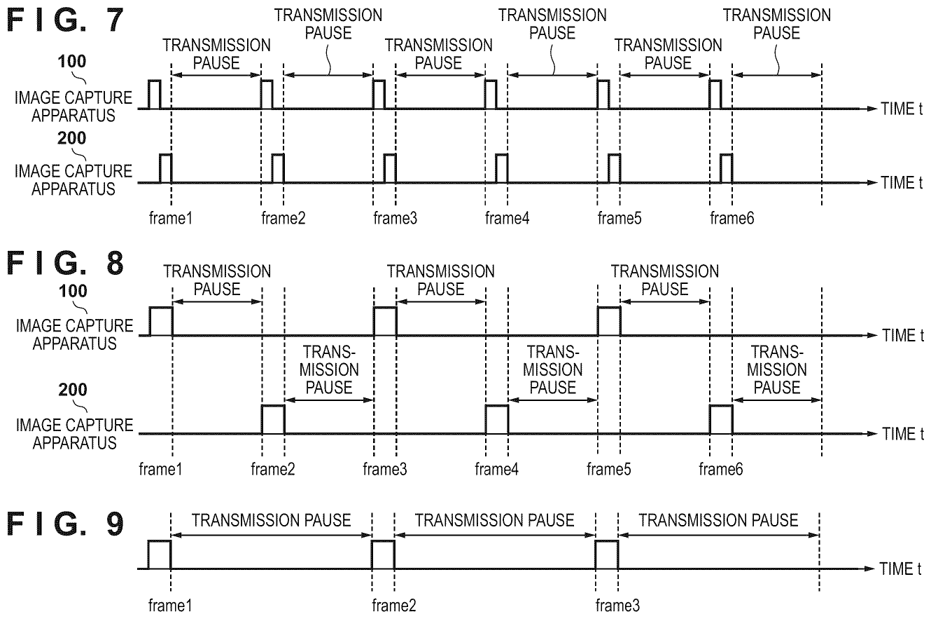

FIG. 7 is a diagram illustrating the state of communication using image division. For example, because the IEEE 802.11ah is subject to a restriction in Japan that the transmission duty cycle is limited to 10%, in order to perform continuous communication, transmission pause periods are required intermittently. In the example of FIG. 7, the image capture apparatus 100 and the image capture apparatus 200 each operates with a 90% pause period, but during cooperative operation, the image quality and the frame rate can be improved compared to that in the first mode by sequentially transmitting the divided images.

FIG. 8 is a diagram illustrating the state of communication using the frame division. It is possible that, without dividing the image by regions, the image capture apparatus 100 and the image capture apparatus 200 alternatively transmit the image in the order of frames. Similarly, in the example of FIG. 8, although the image capture apparatus 100 and the image capture apparatus 200 respectively operates with a 90% pause period, during cooperative operation, the image quality and the frame rate can be improved compared to that of the first mode by sequentially transmitting the divided images.

As described above, according to the second embodiment, in a remote monitoring system and the like using multiple image capture apparatuses, even in a case where the monitoring apparatus 400 performs a long distance communication with the image capture apparatuses 100 and 200 using a single channel, by transmitting the partial images by the image capture apparatuses 100 and 200 so as to cooperate with each other to the monitoring apparatus 400, it is possible to display the improved image quality and the improved frame rate compared to those in the normal operation, thus implementing more detailed monitoring.

In each of the embodiments described above, explanations have been given as to the configuration in which the image capture apparatus 100 and the image capture apparatus 200 cooperate to transmit the partial images to the monitoring apparatuses 300 and 400. However, the configuration may be such that three or more image capture apparatuses cooperate to transmit the partial images to the monitoring apparatus. In this case, the original image is divided into three or more partial images, and it may be sufficient that other ones of the image capture apparatuses transmit to the monitoring apparatus at least other ones of the partial images divided from the original image.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-007978, filed Jan. 20, 2025 which is hereby incorporated by reference herein in its entirety.

What is claimed is:

1. An image capture apparatus comprising:
an image capture unit;
an image processing unit that performs image processing on an image captured by the image capture unit;
a first communication unit that communicates with a first apparatus using a first communication method;
a second communication unit that is capable of communicating with a second apparatus using a second communication method in which a communicable distance is shorter than that of the first communication method; and
a control unit that performs:
first control for causing the first communication unit to transmit, at a first data size, the image captured by the image capture unit to the first apparatus; and
second control for causing the first
communication unit to transmit, to the first apparatus, a portion of the image captured by the image capture unit and having a second data size larger than the first data size, and for causing the second communication unit to transmit at least another portion of the image to the second apparatus.

2. The apparatus according to claim 1, wherein
the second apparatus comprises a third communication unit that is capable of communicating with the first apparatus using the first communication method, and
the second apparatus transmits the at least another portion of the image received from the image capture apparatus to the first apparatus by the third communication unit.

3. The apparatus according to claim 2, wherein
a channel used by the first communication unit of the image capture apparatus is different from a channel used by the third communication unit of the second apparatus.

4. The apparatus according to claim 2, wherein
a channel used by the first communication unit of the image capture apparatus is the same as a channel used by the third communication unit of the second apparatus, and
the first communication unit of the image capture apparatus and the third communication unit of the second apparatus use the same channel in a time-division manner.

5. The apparatus according to claim 1, wherein
the portion of the image is an image obtained by dividing the captured image into a plurality of regions.

6. The apparatus according to claim 1, wherein
the portion of the image is an image obtained by dividing the captured image on a per-pixel basis.

7. The apparatus according to claim 1, wherein
the portion of the image is an image obtained by dividing the captured image on a per-interlaced-scan basis.

8. The apparatus according to claim 4, wherein
the portion of the image is a frame of the captured image, and
in the second control, the first apparatus and the second apparatus alternately transmit the portion of the image in an order of frames.

9. An information processing apparatus comprising:
a communication unit that communicates with a first apparatus and a second apparatus; and
a control unit that performs:
first control for causing the communication unit to receive, at a first data size, an image generated by the first apparatus; and
second control for causing the communication unit to receive, from the first apparatus, a portion of the image generated by the first apparatus and having a second data size larger than the first data size, and for causing the communication unit to receive at least another portion of the image from the second apparatus.

10. The apparatus according to claim 9, further comprising:
a storage unit that stores the portion of the image received from the first apparatus and the other portion of the image received from the second apparatus;
an image processing unit that merges the portion of the image received from the first apparatus and the other portion of the image received from the second apparatus; and
a display unit that displays the image merged by the image processing unit.

11. The apparatus according to claim 9, wherein
the communication unit comprises a communication unit that communicates with the first apparatus and a communication unit that communicates with the second apparatus.

12. The apparatus according to claim 9, wherein
the communication unit communicates with the first apparatus and the second apparatus using the same channel in a time-division manner.

13. The apparatus according to claim 9, wherein
the portion of the image is an image obtained by dividing the image generated by the first apparatus into a plurality of regions.

14. The apparatus according to claim 9, wherein
the portion of the image is an image obtained by dividing the image generated by the first apparatus on a per-pixel basis.

15. The apparatus according to claim 9, wherein
the portion of the image is an image obtained by dividing the image generated by the first apparatus on a per-interlaced-scan basis.

16. The apparatus according to claim 12, wherein
the portion of the image is a frame of the image generated by the first apparatus, and
in the second control, the portion of the image is received alternately from the first apparatus and the second apparatus in an order of frames.

17. A control method executed by an image capture apparatus, wherein
the image capture apparatus comprises:
an image capture unit;
an image processing unit that performs image processing on an image captured by the image capture unit;
a first communication unit that communicates with a first apparatus using a first communication method; and
a second communication unit that is capable of communicating with a second apparatus using a second communication method in which a communicable distanced is shorter than that of the first communication method; and
the control method comprising:
first control for causing the first communication unit to transmit, at a first data size, the image captured by the image capture unit to the first apparatus; and
second control for causing the first communication unit to transmit, to the first apparatus, a portion of the image captured by the image capture unit and having a second data size larger than the first data size, and for causing the second communication unit to transmit at least another portion of the image to the second apparatus.

18. A control method executed by an information processing apparatus, wherein
the information processing apparatus comprises a communication unit that communicates with a first apparatus and a second apparatus, and
the control method comprises:
first control for causing the communication unit to receive, at a first data size, an image generated by the first apparatus; and
second control for causing the communication unit to receive, from the first apparatus, a portion of the image generated by the first apparatus and having a second data size larger than the first data size, and for causing the communication unit to receive at least another portion of the image from the second apparatus.

19. A non-transitory computer-readable storage medium storing a program for causing a computer to function as an image capture apparatus comprising:
an image capture unit;
an image processing unit that performs image processing on an image captured by the image capture unit;
a first communication unit that communicates with a first apparatus using a first communication method;
a second communication unit that is capable of communicating with a second apparatus using a second communication method in which a communicable distance is shorter than that of the first communication method; and
a control unit that performs:
first control for causing the first communication unit to transmit, at a first data size, the image captured by the image capture unit to the first apparatus; and
second control for causing the first
communication unit to transmit, to the first apparatus, a portion of the image captured by the image capture unit and having a second data size larger than the first data size, and for causing the second communication unit to transmit at least another portion of the image to the second apparatus.

20. A non-transitory computer-readable storage medium storing a program for causing a computer to function as an information processing apparatus comprising:
a communication unit that communicates with a first apparatus and a second apparatus; and
a control unit that performs:
first control for causing the communication unit to receive, at a first data size, an image generated by the first apparatus; and
second control for causing the communication unit to receive, from the first apparatus, a portion of the image generated by the first apparatus and having a second data size larger than the first data size, and for causing the communication unit to receive at least another portion of the image from the second apparatus.

21. A system including first, second and third apparatuses,
wherein the firs apparatus comprises:
an image capture unit;
an image processing unit that performs image processing on an image captured by the image capture unit;
a first communication unit that communicates with the third apparatus using a first communication method;
a second communication unit that is capable of communicating with the second apparatus using a second communication method in which a communicable distance is shorter than that of the first communication method; and
a control unit that performs:
first control for causing the first communication unit to transmit, at a first data size, the image captured by the image capture unit to the third apparatus; and
second control for causing the first
communication unit to transmit, to the third apparatus, a portion of the image captured by the image capture unit and having a second data size larger than the first data size, and for causing the second communication unit to transmit at least another portion of the image to the second apparatus.; and
wherein the third apparatus comprises:
a communication unit that communicates with the first apparatus and the second apparatus; and
a control unit that performs:
first control for causing the communication unit to receive, at a first data size, an image generated by the first apparatus; and
second control for causing the communication unit to receive, from the first apparatus, a portion of the image generated by the first apparatus and having a second data size larger than the first data size, and for causing the communication unit to receive at least another portion of the image from the second apparatus.
